(19) United States
(12) Patent Application Publication
(10) Pub. No.: US 2010/0178431 A1
(43) Pub. Date: Jul. 15, 2010

(54) METHOD AND DEVICE FOR THE SOLVENT-FREE PRODUCTION OF ACRYLATE ADHESIVE MASSES

(75) Inventors: Hermann Neuhaus-Steinmetz, Ahrensburg (DE); Christian Harder, Hamburg (DE); Sven König, Wedel (DE); Axel Burmeister, Buchholz (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: Tesa SE, Hamburg (DE)

(21) Appl. No.: 12/598,063

(22) PCT Filed: May 5, 2008
(86) PCT No.: PCT/EP08/55450

§ 371 Date: Mar. 16, 2010

(30) Foreign Application Priority Data
May 11, 2007 (DE) 10 2007 022 726.6

(51) Int. Cl. C08J 7/04; B05C 9/14

(52) U.S. Cl. 427/516; 118/641

(57) ABSTRACT

Method for the solvent-free production of acrylate adhesive masses, which comprises (a) continuously coating a mixture, containing one or more photoinitiators and a monomer mixture comprising (i) 70 to 100% by weight compounds selected from the group consisting of (meth)acrylic acid and the derivatives thereof in accordance with the formula

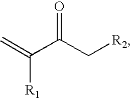

where R₁ is H or CH₃ and R₂ is an alkyl chain having 2 to 20 carbon atoms; (ii) 0 to 30% by weight of olefinically unsaturated monomers having functional groups; and (iii) optionally additional components, or a prepolymer of said monomer mixture on a process carrier; b) polymerizing the coated mixture by applying radiation to the coated sections of the process carrier using visible or ultraviolet light; (c) separating the polymer product from the process carrier and forming the polymer product; (d) transferring the polymer product into a mixing device; (e) mixing the polymer product with additional components in a mixing device; and (f) further processing the polymer product/component mixture obtained in step (e).

The present invention relates to a method for the solvent-free production of pressure-sensitive acrylate adhesives and also to a device suitable for the continuous implementation of the method.

Methods of producing pressure-sensitive acrylate adhesives have been known for a long time. However, in some of the known methods, solvents are used to polymerize the monomers, which is presently considered to be deleterious in respect of environmental considerations. DE 100 53 563 A1 describes a method of producing acrylate hotmelts by free-radical polymerization using a solvent. Following the removal of the solvent in a twin-screw extruder, the polymer is admixed with resins, fillers, and crosslinkers. The mixture can be coated and dried in a tunnel. The method is carried out discontinuously. The method is environmentally harmful and the discontinuous procedure makes it expensive.

Also known is the polymerization of the monomers in a solvent and the removal of the solvent only after the operation of blending with resins, fillers, and crosslinkers, thereby allowing solvent-free coating by means of a nozzle, a roller or an extruder. This procedure is expensive in terms both of apparatus and of time.

WO 2002/092639 A1 describes a method of producing a polymerized pressure-sensitive adhesive by coating monomers or oligomers onto a substrate and polymerizing them thereon by means of an electron beam which generates accelerated electrons. The resulting polymer, however, has a high fraction of residual monomers, which may be harmful to health. Moreover, for the production of pressure-sensitive adhesives, the polymers may not contain any more than small amounts of fillers and resins.

In addition there are further methods known for the UV polymerization of acrylate adhesives on a carrier in web form. In the case of polymerization on a web, it is easy to remove the heat of reaction during the polymerization. In all of the methods described for UV polymerization on a web, the polymer has acquired its ultimate chemical composition following UV polymerization. At most, an additional operation of crosslinking is carried out immediately following the polymerization on the same web. Possibilities of supplying the polymerized composition, via the removal from the web, to direct further processing in assemblies are not found and are also not contemplated.

In the case of a thermally insulated composition, the heat of polymerization would lead to an increase in the temperature of the composition by 200° C. or more.

In the case of solvent-free polymerization in tanks or other reactors, the removal of heat from substances of relatively high viscosity, with a heat of reaction like that in the polymerization of acrylates, presents problems. Consequent restrictions on the selection of the constituents of the composition and on the operating regime impose limits on the properties of the adhesive in the eventual product.

It is an object of the invention to eliminate the disadvantages according to the prior art. The intention more particularly is to specify a method for the solvent-free production of a pressure-sensitive acrylate adhesive which has no crosslinking or only slight crosslinking, the method not only being amenable to continuous implementation but also taking little time and involving little cost, and allowing the free addition of components such as resins, aging inhibitors, photoinitiators for subsequent UV crosslinking, and further constituents between the implemented polymerization on a web and the continuous further processing.

This object is achieved by the features of claims 1 and 20. Useful embodiments of the invention are evident from the features of claims 2 to 19 and 21 to 33.

The invention provides a method for the solvent-free production of pressure-sensitive acrylate adhesives, comprising

(a) continuous coating of a mixture comprising one or more photoinitiators and also a monomer mixture which comprises
(i) 70% to 100% by weight of compounds from the group of (meth)acrylic acid and also derivatives thereof, corresponding to the following general formula

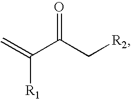

where R₁ is H or CH₃ and R₂ is an alkyl chain having 2 to 20 carbon atoms;
(ii) 0% to 30% by weight of olefinically unsaturated monomers having functional groups; and
(iii) if desired, further components,
or a prepolymer of this monomer mixture, onto a process liner;
(b) polymerization of the coated mixture by irradiation of the coated sections of the process liner with visible or ultraviolet light;
(c) separation of the polymer from the process liner and shaping of the polymer;
(d) transfer of the polymer to a mixing device;
(e) mixing of the polymer with further components in a mixing device; and
(f) further processing of the polymer/components mixture obtained in step (e).

The method can be carried out continuously. The method of the invention thus permits the continuous, solvent-free production of pressure-sensitive acrylate adhesives under conditions which in terms both of time and of apparatus are cost-effective. The possibility of admixing further components following polymerization in step (b) permits significantly higher quantities of fillers and resins. The resins and fillers need not be transparent to UV radiation.

The method of the invention encompasses the coating of a mixture of acrylate monomers or oligomers on the one hand and of at least one photoinitiator on the other onto a process liner. The mixture is polymerized by means of UV radiation, the polymerization being carried out preferably in an inert atmosphere.

Inertization is achieved preferably by carrying out coating between two release films. The second, upper release film is preferably removed again after the UV polymerization. The resulting polymer is separated from the process liner by means of a suitable device and is shaped to form a strand. The strand is mixed in a continuously operating mixing assembly with further components such as resins, fillers, and crosslinkers. The resulting polymer/components mixture can then be subjected to further processing, by—for example—being coated onto a carrier material for a pressure-sensitive adhesive tape. The mixture ought to be a spreadable composition.

Prior to implementation of step (a) of the method of the invention, the monomer mixture, comprising the components (i), (ii), and, optionally, (iii), is prepolymerized in one embodiment of the invention, to give a spreadable composition which is then applied in step (a) to the process liner. For this purpose the monomer mixture may comprise a second photoinitiator. The prepolymerization is preferably carried out continuously in a downflow reactor. In a continuous reactor of this kind the monomer mixture is produced in web form from a slot die within the reactor at a window through which UV light radiates from the outside. A downflow reactor is typically located in a loop with multiple flow traversal of composition, such as flow of removal composition. A unit of this kind is also able to supply the UV polymerization on the web directly, via a hose, with partially polymerized composition. Via a mixing assembly, it is also possible in this case for additional components to be mixed into the composition, which is still of low viscosity.

Alternatively the prepolymerization may also take place in an extruder, using a thermal crosslinker added in a low amount.

The prepolymer formed from the components (i), (ii), and, optionally, (iii) is applied together with a first photoinitiator to the process liner.

Alternatively the components (i), (ii), and, optionally, (iii) can be applied together with the second photoinitiator to the process liner without partial polymerization beforehand. In this case there is no need for a second photoinitiator as component (iii).

For the method of the invention for the solvent-free production of pressure-sensitive adhesives it is preferred as component (i) to use 2-ethylhexyl acrylate, methyl acrylate, tert-butyl acrylate, acrylamides, substituted acrylamides, and mixtures of these compounds. A particularly preferred component (i) is a mixture of 2-ethylhexyl acrylate and methyl acrylate (EHA/BA).

As component (ii) use is made of olefinically unsaturated compounds which preferably contain two functional groups, with a fraction of 0 to 30 percent by weight. Examples of olefinically unsaturated compounds of this kind are (meth)acrylic acid and the methyl esters thereof, methacrylic acid derivatives such as (meth)acrylamides, N-substituted (meth)acrylamides, dimethylacrylic acid, trichloroacrylic acid, hydroxyalkyl (meth)acrylate, amino-containing (meth)acrylates, hydroxyl-containing (meth)acrylates, more preferably 2-hydroxyethyl (meth)acrylate, 2-hydroxypropyl (meth)acrylate, and/or 4-hydroxybutyl (meth)acrylate, acrylonitrile, and also 3-vinyl compounds such as vinyl esters, vinyl ethers, vinyl halides, vinylidene halides, and nitrites of ethylenically unsaturated hydrocarbons, vinyl compounds having aromatic rings and heterocycles in a-position, more particularly vinylacetic acid and vinyl acetate, N-vinylformamide, vinylpyridine, ethyl vinyl ether, vinyl chloride, vinylidene chloride, and also maleic anhydride, styrene, styrene compounds, β-acryloyloxypropionic acid, fumaric acid, crotonic acid, aconitic acid and/or itaconic acid; the above listing is only exemplary and not conclusive. Particular preference is given to acrylic acid, hydroxymethyl acrylate, hydroxypropyl acrylate, fumaric acid, and maleic anhydride.

As first and second photoinitiators it is possible to use all Norrish type I photoinitiators (also referred to below for short as type 1 photoinitiators). The fraction of the photoinitiators, based on the monomers employed, is advantageously between 0.05 and 2, preferably between 0.1 and 1 percent by weight. With preference it is possible for example to use Irgacure 901 (from Ciba Geigy). Photoinitiator mixtures as well are very suitable for initiation for the purposes of the invention. Great preference is given to using photoinitiators with long wave absorption, since they possess a great depth of penetration and therefore penetrate the monomer/polymer mixture more easily. Hence it is possible to polymerize greater layer thicknesses.

A linear polymerization is initiated preferably with a Norrish type I photoinitiator. Norrish type II photoinitiators (type II photoinitiators) give rise to a greater proportion of grafting reactions (for the preparation of branched polyacrylates) and are therefore metered in preferably in the course of the UV polymerization. Nevertheless it is also possible to initiate UV polymerizations using type II photoinitiators.

Norrish type I photoinitiators are those compounds which on irradiation with light undergo decomposition in accordance with a Norrish type I reaction. This reaction is, classically, a photofragmentation of a carbonyl compound, in which the bond to a carbon atom positioned α to the carbonyl group is cleaved free-radically (a splitting), thus producing a free acyl radical and a free alkyl radical. For the purposes of the invention, the Norrish photoinitiators are taken to include even those where, rather than the carbonyl group, there is another functional group and where the cleavage relates to the bond between this group and an oc carbon atom.

Norrish type II photoinitiators react to irradiation with light by undergoing decomposition in accordance with a Norrish type II reaction with hydrogen abstraction—this is an intramolecular reaction.

In the case of aliphatic ketones, it is possible here for a hydrogen to be eliminated from the y-position with respect to a functional group corresponding to that set out above.

Inventive examples of Norrish photoinitiators of both types are benzophenone derivatives, acetophenone derivatives, benzil derivatives, benzoin derivatives, hydroxyalkylphenone derivatives, phenyl cyclohexyl ketone derivatives, anthraquinone derivatives, thioxanthone derivatives, triazine derivatives or fluorenone derivatives, this enumeration not being conclusive. The type I initiators include more particularly aromatic carbonyl compounds, such as benzoin derivatives, benzil ketals, and acetophenone derivatives. Type II photoinitiators are, in particular, aromatic ketones, such as benzophenone, benzil or thioxanthones, for example.

In accordance with step (a) the mixture comprising the first photoinitiator and the monomer mixture or the prepolymer is applied continuously, preferably by means of a rotating coating bar, between a process liner and a release liner film which with a predetermined speed are unwound continuously from unwind rollers and passed via rollers to a winding roller. Following the application of the mixture, the coated sections of the process liner are passed through a UV irradiation unit (step (b)).

An alternative option to the use of a release liner film is the irradiation of the mixture with UV light in an inert gas atmosphere, such as nitrogen, helium or argon, for example. The process liner is preferably a release film, which is also referred to below as first release film.

As process liners it is possible for example to use films (polyesters, PET, PE, PP, BOPP, PVC), nonwovens, foams, woven fabrics, and woven-fabric films, and also release papers (glassine, HDPE, LDPE). Films are preferred. At least the upper release film must be sufficiently pervious to UV rays. In the case of UV irradiation from the underside of the web as well, the first release film must also be transparent for the UV wavelength range in which the photoinitiators are sensitive.

Depending on the photoinitiator used, the irradiating wavelength selected is between 200 and 450 nm. For example, the UV irradiation facility may comprise high-pressure or medium-pressure mercury lamps with an output of, for example, 80 to 200 W/cm or more.

The heat of reaction during the UV polymerization heats up the mixture very sharply. In order to avoid the sudden release of the entire heat of reaction, and also in order to attain long polymer chains, it is therefore advantageous to use low-performance, low-pressure mercury tubes with UV wavelengths tailored to the photoinitiators employed. For the UV polymerization, a plurality of low-pressure mercury UV tubes are disposed in series in the web direction. For cooling it is advantageous to arrange UV tubes between the air jets of a cooling tunnel.

In order to achieve sufficiently complete reaction over the depth of the mixture it is possible to mount UV tubes on both sides of the web. The chain length of the polymers is set via the intensity of the UV radiation, the operating temperature, the distance between the UV tubes, the web speed, and the photoinitiator content. The operational parameters and the formula are advantageously selected such as to minimize formation of crosslinks between the polymer chains. Crosslinked compositions are difficult to further-process and coat.

Advantageously the polymerization is carried out at least to a conversion of 98% of the monomers. Provision may be made for unreacted monomers or oligomers to be removed after UV irradiation, by means of a device intended for that purpose.

In one embodiment of the invention the coated sections of the process liner may be covered with a second release film. This second release film is removed following passage through the UV irradiation unit. The second release film is unwound continuously from a second unwind roller and is passed via rollers to a second winding roller. Examples for the second release film are the examples for the process liner, with films again being preferred.

The UV irradiation facility preferably has a first, uncooled section and also a second, cooled section.

In step (c) the polymer obtained by means of UV radiation, on the process liner, is shaped to form a strand. This is done using a strand-forming facility. Following strand formation, the process liner is removed and wound up on a winding roll. The strand of the polymer is then supplied to a mixing facility (step (d)), a twin-screw extruder (TSE) or a planetary roller extruder (PRE), for example. There the strand is mixed with further components—for example, resins, fillers and/or crosslinkers.

Resins may be admixed to the polymer for the purpose in particular of enhancing the adhesive properties. Resins which can be used include, for example, terpene resins, terpene-phenolic resins, C₅ and C₉ hydrocarbon resins, pinene resins, indene resins, and rosins, both alone and in combination with one another. In principle, however, it is possible to use all of the resins that are soluble in the corresponding polymer, reference being made more particularly to all aliphatic, aromatic, and alkylaromatic hydrocarbon resins, hydrocarbon resins based on pure monomers, hydrogenated hydrocarbon resins, functional hydrocarbon resins, and also natural resins. Particular preference is given to terpene-phenolic resins, an example being DT 110, produced by DRT, hydrocarbon resins, and rosins.

In addition it is possible for various fillers (for example, carbon black, chalk, Aerosil, TiO₂, fibers, solid or hollow beads of glass or other materials), nucleators, compounding agents, aging inhibitors, light stabilizers, ozone protectants, fatty acids, plasticizers, nucleators, expandants, accelerants and/or extenders to be added. Particularly preferred fillers are chalk, Aerosil, fibers, and solid glass beads.

For certain applications as a pressure-sensitive adhesive it may be necessary to crosslink the polymer in the polymer/components mixture, more particularly for the purpose of raising the cohesion. For the method of the invention, therefore, it is very advantageous to add crosslinkers to the polymer.

Crosslinkers which can be used are all of the difunctional or polyfunctional compounds that are known to the skilled worker and whose functional groups are able to enter into a linking reaction with the polyacrylates, more particularly addition polymerization reactions, polycondensation reactions or polyaddition reactions. Use is made more particularly of difunctional or polyfunctional acrylates and/or methacrylates, difunctional or polyfunctional isocyanates or difunctional or polyfunctional epoxides. For UV or EB curing, polyfunctional acrylates are preferred.

It is also possible to admix substances which crosslink under UV radiation, such as UV photoinitiators, for example. As photoinitiators it is possible to use benzophenone derivatives, acetophenone derivatives, benzil derivatives, benzoin derivatives, hydroxyalkylphenone derivatives, phenyl cyclohexyl ketone derivatives, anthraquinone derivatives, thioxanthone derivatives, triazine derivatives or fluorenone derivatives, this enumeration not being conclusive. It is preferred to use type II photoinitiators.

Furthermore, it is also possible for all of the promoters known to the skilled worker to be admixed to the polymer, which might make the UV crosslinking more efficient.

Preferred crosslinkers are metal chelates, examples being aluminum chelates and titanium chelates, isocyanates, blocking-free isocyanates, phenolic resins, melamine resins, epoxides, and UV or EB curatives. The metal chelates are present preferably in an amount of 0.1 to 1, more preferably 0.1 to 0.5, based on the weight of the polymer/components mixture.

From the polymer/components mixture produced by the method of the invention it is possible to obtain a pressure-sensitive adhesive which is particularly suitable for the production of, for example, adhesive tapes. For this purpose, the polymer/components mixture is applied to a carrier material. As carrier material, for adhesive tapes, for example, it is possible in this context to use the materials that are customary and familiar to the skilled worker, such as films (polyesters, PET, PE, PP, BOPP, PVC), nonwovens, foams, woven fabrics, and woven-fabric films, and also release papers (glassine, HDPE, LDPE). This enumeration is not conclusive.

The application of the polymer/components mixture to the carrier material may take place by means of a nozzle or a roller applicator. Crosslinking may then be carried out following application, preferably directly on the carrier material, preferably by UV radiation or by ionizing radiation, such as electronic radiation, for example. In certain circumstances, furthermore, it is also possible for crosslinking to take place thermally.

A device for implementing the method of the invention comprises

(a) a facility for continuously coating a mixture onto the process liner;
(b) at least one UV irradiation facility for polymerizing the coated mixture by irradiating the coated sections of the process liner with ultraviolet light;
(c) a facility for separating the polymer obtained in step (b) from the process liner;
(d) a facility for transferring the polymer into a mixing device; and
(e) a facility for mixing the polymer with further components.

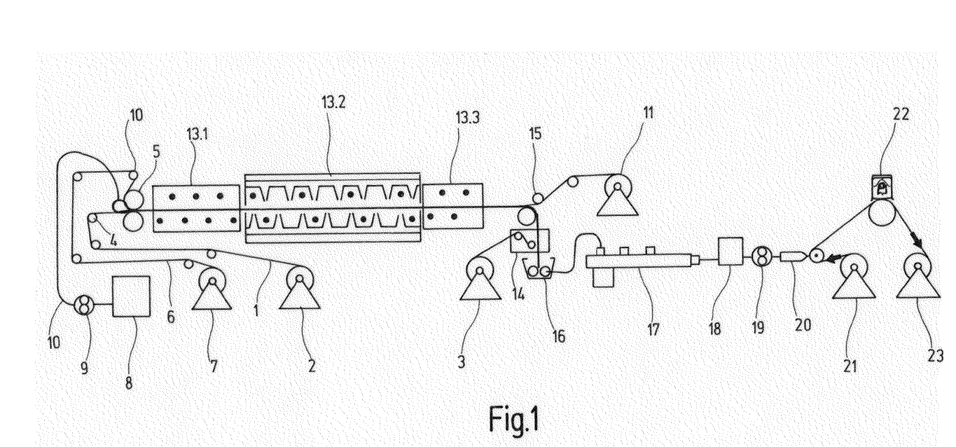

The invention is elucidated in more detail below, with reference to the drawing. In that drawing, FIG. 1 shows a diagrammatic representation of a device for implementing steps (a) to (e) of the method of the invention.

### EXAMPLES

### Example 1

FIG. 1 describes an example of the solvent-free production of acrylate adhesives. A first release film 1, which serves as process liner, is unwound continuously from an unwind roll 2 and, after passing through facilities of the device, is rolled up onto a winding roller 3. The path traveled by the release film 1 (arrow A) is determined by rollers and rolls 4. A coating bar 5 coats the mixture defined in step (a) of the method of the invention onto the release film 1. For this purpose the mixture is pumped by a regulated gear pump 9 from a container 8 through a hose 10 into the applicator 3 onto the release film 1.

A second release film 6 is passed through the applicator 3 as well, beneath the top coating bar, and so, downstream of the applicator 3, the mixture is located between the two release films. The second release film 6, like the release film 1, is unwound continuously from an unwind film 7, guided via rollers and rolls, and finally wound up on a winding roll 9 following UV polymerization. The gap between the coating bars is set such that the polymer has a film thickness of 2 mm for a coating width of 50 cm.

The resulting three-ply laminate of release film 1, coated mixture, and release film 6 is subsequently passed through the UV irradiation facility 13. The double-sided lining for the mixture with the release films effects inertization of the mixture with respect to atmospheric oxygen in the course of UV irradiation. The UV irradiation polymerizes the mixture between the two release films. For the purpose of UV polymerization, a plurality of UV tubes are disposed in series in the web direction.

The heat of reaction during the UV polymerization heats up the mixture very sharply. In order to avoid the sudden release of the entire heat of reaction, and also in order to attain long polymer chains, low-pressure mercury tubes, which are of very low-performance in relation to medium-pressure mercury tubes, and which have UV wavelengths tailored to the photoinitiators used, are employed; in this case, “Cleo Performance R” sunbed tubes from Philips with a principal wavelength of 355 nm.

The irradiation facility 13 has a first section 13.1 whose tunnel is traversed by the three-ply laminate without cooling. The first section 13.1 is followed by a second section 13.2, whose tunnel is cooled. Here the UV tubes are disposed between the air jets that are used for cooling. The second section 13.2 is followed by a third section 13.3, which is again uncooled. The major part of the polymerization is concluded in section 13.2. In section 13.3, only a little heat of reaction is still released, and a polymerization conversion is achieved down to a residual monomer content of 0.8% to 3%.

In order to achieve sufficiently complete reaction over the depth of the mixture it is possible to mount UV tubes on both sides of the web. The chain length of the polymers is set via the intensity of the UV radiation, the operating temperature, the distance between the UV tubes, the web speed, and the photoinitiator content. The operational parameters and the formula are selected such as to minimize formation of crosslinks between the polymer chains.

The siliconized PET film used as release film 1 and the siliconized polypropylene film used as release film 6 are transparent to the UV wavelength range that is employed. They are used more than once.

Following the polymerization, the second release film 6 is removed and is rolled up with the winder 9. Located below a roller 14, which diverts the now only two-ply laminate of release film 1 and the polymer, is an open twin-screw extruder 16. The polymer is drawn in by the screws and thereby removed from the release film. In the twin-screw extruder 16 the polymer is heated in order to lower the viscosity, and is passed via a discharge screw into a mixing extruder 17.

In the first part of the mixing extruder 17, residual monomers still present are stripped off. In the subsequent parts, resins, aging inhibitors, and UV crosslinkers are added. The downstream thermally conditioned holdup means 18, with a short residence time of the adhesive, decouples the production of acrylate adhesive from the subsequent coating line for adhesive tapes.

For the coating of a PP carrier having a siliconized reverse face, the adhesive is conveyed, using a gear pump 19 mounted in the base of the holdup means, into a slot die 20. The layer thickness of the adhesive, of 25 μm, is a product of the throughput of composition at the gear pump 19, the width of the die, and the web speed of the coating line. The web speed is harmonized with the flow of composition supplied from the UV polymerization. Coating is followed by crosslinking with a UVC dose of 45 mJ/cm² through the UV unit 22, and by subsequent winding with the winder 23.

### Example 2

All of the steps are identical to Example 1. Instead of the UV crosslinking unit 22, though, an electron beam installation is used for crosslinking, and a double-sided adhesive tape is produced with a 12 μm PET carrier and two layers of composition with a thickness each of 150 μm. To this end, coating takes place in a first operation onto a double-sided release paper. Following the subsequent electron-beam irradiation with a dose of 41 kGy at an acceleration voltage of 137 kV, winding is preceded by the lamination of the 12 μm PET carrier onto the adhesive side (not shown). In a second operation, coating then takes place onto the remaining open side of the carrier, and electron-beam irradiation with 45 kGy at 176 kV. The electron beam installation has a titanium vacuum window with a thickness of 9 μm, and the air gap between vacuum window and product surface is 15 mm. The irradiation chamber is inertized with nitrogen.

### Example 3

All of the steps are identical to Example 1. The twin-screw extruder 16, though, is absent. Instead, the polymer is removed from the release film 1 via an antiadhesive roller and then drawn into the mixing extruder 17 through a square opening measuring 4×4 cm, which is formed by an arrangement of four driven antiadhesive rollers, via further, shaping antiadhesive rollers.

### Example 4

All of the steps are identical to Example 1. Downstream of the third section 13.3 of the UV irradiation facility 13, though, there is a high-powered doped medium-pressure mercury lamp, in order to bring the residual monomer content to an achievable minimum.

### LIST OF REFERENCE NUMERALS

1 first release film (process liner)
2 unwind roller for release film 1
3 winding roller for release film 1
4 guide rolls and guide rollers for release film 1
5 coating bar
6 second release film
7 unwind roller for release film 6
8 container for prepolymer
9 gear pump for prepolymer
10 hose for composition
11 winding roller for release film 6
12 guide rolls and guide rollers for release film 6
13 UV irradiation facility
13.1 first section of the UV irradiation facility
13.2 second section of the UV irradiation facility
13.3 third section of the UV irradiation facility
14 facility for separating the release film 6
15 facility for separating the release film 1 (deflection roller)
16 open twin-screw extruder for drawing in and conveying the polymer
17 mixing assembly for forming the polymer/components mixture
18 holdup means for decoupling the flows of composition
19 gear pump
20 slot die for coating
21 unwinder, adhesive tape carrier
22 UV crosslinking unit
23 adhesive tape winder

1. A method for the solvent-free production of pressure-sensitive acrylate adhesives, comprising
(a) continuous coating of a mixture comprising one or more photoinitiators and a monomer mixture which comprises
(i) 70% to 100% by weight of compounds selected from the group consisting of (meth)acrylic acid and derivatives thereof, corresponding to the formula 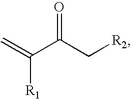
where R₁ is H or CH₃ and R₂ is an alkyl chain having 2 to 20 carbon atoms;
(ii) 0% to 30% by weight of olefinically unsaturated monomers having functional groups; and
(iii) optionally, further components,
or a prepolymer of this monomer mixture, onto a process liner;
(b) polymerization of the coated mixture by irradiation of the coated sections of the process liner with visible or ultraviolet light;
(c) separation of the polymer from the process liner and shaping of the polymer;
(d) transfer of the polymer to a mixing device;
(e) mixing of the polymer with further components in a mixing device; and
(f) further processing of the polymer/components mixture obtained in step (e).

2. The method of claim 1, wherein the first photoinitiator is used in a fraction of 0.05% to 2% by weight, based on the monomer mixture.

3. The method of claim 2, wherein a first photoinitiator is used in an amount of 0.1% to 1% by weight, based on the monomer mixture.

4. The method of claim 3, wherein the prepolymer is prepared from the monomer mixture, the monomer mixture comprising as further component (iii) a second photoinitiator.

5. The method of claim 1, wherein said mixture comprises said prepolymer and the prepolymer is prepared in a downflow reactor.

6. The method of claim 1, wherein the viscosity of the mixture applied in step (a) to the process liner is made such that it is spreadable.

7. The method of claim 1, wherein step (b) is carried out in an inert atmosphere.

8. The method of claim 1, wherein step (b) comprises the passing of the process liner through at least one UV irradiation facility.

9. The method of claim 8, wherein step (b) comprises the passing of the process liner first through an uncooled UV irradiation facility and subsequently through a cooled UV irradiation facility.

10. The method of claim 8 wherein the UV irradiation facilities used are low-pressure mercury lamps having wavelengths adapted to the photoinitiators.

11. The method of claim 10, wherein the low-pressure mercury UV lamps are mounted in a cooling zone between the air jets.

12. The method of claim 1, wherein the step (c) removal of the polymer from the process liner is accomplished by drawing-in of the polymer using the screws of a twin-screw extruder with a discharge screw, the discharge screw performing the step (d) transfer of the polymer into a mixing device.

13. The method of claim 1, wherein the step (c) removal of the polymer from the process liner takes place via antiadhesive rolls and the shaping of the polymer to a strand takes place via further antiadhesive rolls, which optionally are driven in part, said strand being transferred, as per step (d), into a mixing device.

14. The method of claim 1, wherein the step (d) transfer of the polymer into a mixing device is accomplished using roll knives which slit the polymer into elongated strips without severing the process liner, and using antiadhesive rolls which remove the polymer strips from the process liner as per step (c) and pass them to the intake of the mixing assembly.

15. The method of claim 1, wherein in step (e) said further components comprise resins, fillers, crosslinkers, and mixtures thereof.

16. The method of claim 1, wherein the mixing of the polymer with the further components is performed in a twin-screw extruder or planetary roller extruder.

17. The method of claim 1, wherein step (f) comprises the depletion of residual monomers.

18. The method of claim 1, wherein step (f) comprises coating onto a backing for the purpose of producing an adhesive tape.

19. The method of claim 1, wherein step (f) includes a holdup of composition prior to further processing.

20. A device for the continuous, solvent-free production of pressure-sensitive acrylate adhesives by the method of claim 1, comprising:
(a) a facility (5) for continuously coating a mixture onto a process liner (1);
(b) at least one UV irradiation facility (10) for polymerizing the coated mixture by irradiating the coated sections of the process liner (1) with ultraviolet light;
(c) a facility (14) for separating the polymer obtained in step (b) from the process liner;
(d) a facility for transferring the polymer into a mixing device; and
(e) a facility (15) for mixing the polymer with further components.

21. The device of claim 20, further comprising (f) a facility for further-processing the polymer/components mixture.

22. The device of claim 20 wherein the process liner (1) is a backing for an adhesive tape.

23. The device of claim 20, comprising an unwind roll (2) and a winding roll (3) for the process liner (1), and rollers (4) for guiding the process liner (1) through the facilities (a) to (c).

24. The device of claim 20, wherein the facility (5) for continuously coating a mixture onto the process liner comprises a coating bar.

25. The device of claim 20, wherein the UV irradiation facility (10) has a cooling tunnel through which the coated process liner (1) is passed.

26. The device of claim 1, wherein the UV irradiation facilities have low-pressure mercury lamps having wavelengths adapted to the photoinitiators.

27. The device of claim 20, wherein low-pressure mercury UV lamps are mounted in a cooling tunnel between the air jets.

28. The device of claim 20, wherein the unit for the step (c) removal of the polymer from the process liner is a twin-screw extruder and the unit for the step (d) transfer of the polymer into a mixing device has a discharge screw.

29. The device of claim 20, wherein the unit for the step (c) removal of the polymer from the process liner and for strand-forming and also for the step (d) transfer of the polymer into a mixing device has antiadhesive rolls, which in part are driven.

30. The device of claim 20, wherein the unit for the step (d) transfer of the polymer into a mixing device is a unit having roll knives which slits the polymer into elongated strips without severing the process liner, and possesses antiadhesive rolls which take off the polymer strips from the process liner in step (c) and pass them to the intake of the mixing assembly.

31. The device of claim 20, wherein the unit for depletion of residual monomers is a devolatilizing extruder.

32. The device of claim 20, wherein the facility (15) for mixing the polymer with further components is a twin-screw extruder or planetary roller extruder.

33. The device of 20 wherein the facility for further-processing the polymer/components mixture is a roller applicator or a nozzle.

34. The device of claim 20, wherein the facility for temporarily storing the polymer/components mixture is a thermally conditioned holdup means with short residence times.

35. The method of claim 9 wherein the UV irradiation facilities are low-pressure mercury lamps having wavelengths adapted to the photoinitiators.

36. The method of claim 35, wherein the low-pressure mercury UV lamps are mounted in a cooling zone between the air jets.
